(19) United States
(12) Patent Application Publication
(10) Pub. No.: US 2018/0293475 A1
(43) Pub. Date: Oct. 11, 2018

(54) TWO-PLY LABEL SIMULTANEOUSLY CONCEALING DATA AND DISPLAYING DATA

(71) Applicant: CPS-IL, LLC, Chicago, IL (US)

(72) Inventors: Karen Marie BROOKER, Winfield, IL (US); James COONEY, Carol Stream, IL (US); Timothy JOHNSON, Elmhurst, IL (US)

(21) Appl. No.: 15/946,207

(22) Filed: Apr. 5, 2018

Related U.S. Application Data
(60) Provisional application No. 62/536,296, filed on Jul. 24, 2017.
(60) Provisional application No. 62/481,774, filed on Apr. 5, 2017.

(51) Int. Cl. G06K 19/06

(52) U.S. Cl. CPC G06K 19/06046; G06K 19/06028

(57) ABSTRACT

A two-ply label simultaneously concealing data and displaying data for a substrate having a substrate surface with concealable first-data thereon has a first-ply having an upwardly-facing first-ply surface with a first-data revealing portion and a downwardly-facing first-ply surface. A first adhesive is on the downwardly-facing first-ply surface. A second-ply has an upwardly-facing second-ply surface with second-data disposed and displayed on a portion thereof and a downwardly-facing second-ply surface opposing the upwardly-facing first-ply surface. The second-ply has a first-data concealing portion overlaying the first-data revealing portion. A second adhesive releasably adheres the downwardly-facing second-ply surface to the upwardly-facing first-ply surface. The first-data is concealed by the label when the downwardly-facing first-ply surface is permanently adhered to the substrate surface by the first adhesive and the first-data concealing portion of the second-ply overlays the first-data, and is revealed when the first-data concealing portion of the second-ply is separated from the first-ply.

### CROSS-REFERENCE TO RELATED APPLICATIONS

This application claims priority to U.S. Provisional Patent Application No. 62/481,774, filed Apr. 5, 2017, and U.S. Provisional Patent Application No. 62/536,296, filed Jul. 24, 2017, the disclosures of which are incorporated herein by reference in their entirety.

### BACKGROUND OF THE INVENTION

The present invention relates to a two-ply label simultaneously concealing data and displaying data affixable to a substrate. More particularly, the present invention relates to a two-ply label simultaneously concealing data and displaying data affixable to a card, such as a stored value card.

Many stored value cards are distributed at brick-and-mortar merchant locations or other physical retail environments such as banks, universities, post offices, and transit stations. These stored value cards are typically “activated” at the point of distribution and subsequently “redeemed” by the consumer for some sort of value, such as cash, merchandise, or services. For the purposes of this invention, “stored value cards” refers to objects that may be constructed of one or more of a variety of materials, including but not limited to plastic, paper, wood, metal, or fabric. Stored value cards may take the form of traditional “CR80” cards, of non-traditional shaped cards, of key tags, or of any other physical forms, with the condition that one of the primary functions of these objects is to hold monetary or other value that can be redeemed by consumers in possession of the stored value cards.

In some instances, the data present on stored value cards that allow for card redemption may take the form of optical characters, barcodes, or other symbols that are visible and may therefore be fraudulently read, scanned, photo-copied, or otherwise captured before the cards have been properly distributed to consumers. Criminals wishing to steal value from the cards may discreetly capture this data in some manner and then return the cards to the display rack or other point of distribution and wait for the cards to be activated and distributed to unsuspecting consumers. The criminals may then use the secretly captured data to quickly drain the value of the cards, leaving the legitimate card holder with the inability to redeem the card for its intended value. This type of “counterfeit” fraud is costly, may damage the image of the issuing brand and/or the distribution partner's brand, and over time may erode consumers' willingness to purchase and use stored value cards.

In other instances, the activation, redemption, or other use of a stored value card may require the presence of multiple data fields on the stored value card. It may not be immediately obvious to the card holder and others which data field is required for a specific step of activation, redemption, or other use. For this reason, the simultaneous visibility of more than one element of data on a stored value card (for instance, both an activation code and a redemption code) may lead to confusion, error, or delay during steps of activation, redemption, or other use.

Accordingly, there is a need in the stored value card art for a two-ply label simultaneously concealing data and displaying data that will reduce an issuer's risk of fraud by providing a simple, practical, and affordable way to protect optical redemption data from capture prior to card issuance.

Further, there is a need in the stored value card art for a two-ply label simultaneously concealing data and displaying data that displays data needed for the initial or earlier step(s) and hides data needed for subsequent step(s).

### BRIEF SUMMARY OF THE INVENTION

Briefly stated, one embodiment of the present invention is directed a two-ply label simultaneously concealing data and revealing data for a substrate having a substrate surface with concealable first-data thereon. The label comprises a first-ply having an upwardly-facing first-ply surface and a downwardly-facing first-ply surface, the first-ply having a first-data revealing portion. A first adhesive is on the downwardly-facing first-ply surface. A second-ply has an upwardly-facing second-ply surface and a downwardly-facing second-ply surface. The downwardly-facing second-ply surface opposes the upwardly-facing first-ply surface. The second-ply has a first-data concealing portion overlaying the first-data revealing portion. A second adhesive releasably adheres the downwardly-facing second-ply surface to the upwardly facing first-ply surface. The first-data is concealed by the label when the downwardly-facing first-ply surface is permanently adhered to the substrate surface by the first adhesive and the first-data concealing portion of the second-ply overlays the first-data, and the first-data is revealed when the first-data concealing portion of the second-ply is separated from the first-ply. Second-data is disposed and displayed on a portion of the upwardly-facing second-ply surface.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, the drawings show embodiments which are presently preferred. It should be understood, however, that the invention is not limited to the precise arrangements and instrumentalities shown.

In the drawings:

FIG. 1 is a top plan view of a preferred embodiment of the two-ply data concealing label in accordance with the present invention;

FIG. 2 is an exploded cross sectional view of the two-ply data concealing label of FIG. 1; and

FIG. 3 is a top plan view of a preferred embodiment of the two-ply data concealing label having text on the upwardly-facing second-ply surface in accordance with the present invention;

FIG. 4 is an enlarged portion of the two-ply data concealing label of FIG. 3 showing the tamper evidencing zippers in accordance with the present invention;

FIG. 5 is an enlarged partial top plan view of a preferred embodiment of a two-ply data concealing label having tamper evidencing slits in accordance with the present invention; and

FIG. 6 is a top perspective view of two reels of the two-ply data concealing label of FIG. 1.

### DETAILED DESCRIPTION OF THE INVENTION

Reference will now be made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The words “right,” “left,” “lower” and “upper” designate directions in the drawings to which reference is made. The words “inwardly” and “outwardly” refer to directions toward and away from, respectively, the geometric center of the cutter deck leveling fine adjustment, and designated parts thereof. The terminology includes the words noted above, derivatives thereof and words of similar import.

Although the words first, second, etc., are used herein to describe various elements, these elements should not be limited by these words. These words are only used to distinguish one element from another. For example, first data could be termed second data, and, similarly, second data could be termed first data, without departing from the scope of the present invention.

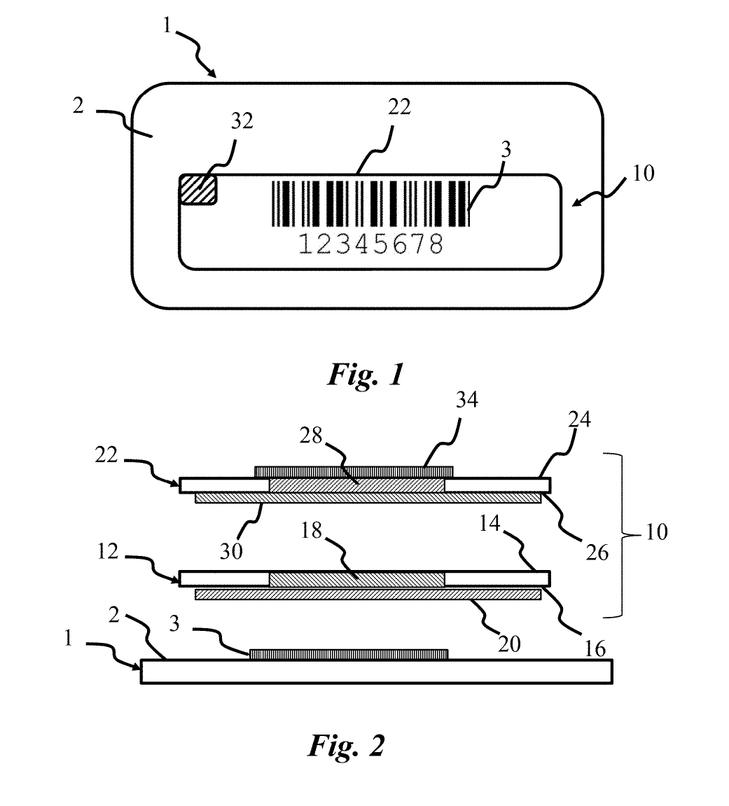

Referring to the drawings in detail, where like numerals indicate like elements throughout, there is shown in FIGS. 1 and 2, a first preferred embodiment of the two-ply label simultaneously concealing data and revealing data, generally designated 10, and hereinafter referred to as the “label” 10 in accordance with the present invention. The label 10 is a two-ply data concealing label for a substrate surface 1 having a substrate surface 2 with concealable first-data 3 thereon.

The label 10 comprises a first-ply 12 having an upwardly-facing first-ply surface 14 and a downwardly-facing first-ply surface 16. The first-ply 12 has a first-data revealing portion 18. A first adhesive 20 is on the downwardly-facing first-ply surface 16. A second-ply 22 has an upwardly-facing second-ply surface 24 and a downwardly-facing second-ply surface 26. The downwardly-facing second-ply surface 26 opposes the upwardly-facing first-ply surface 14. The second-ply 22 has a first-data concealing portion 28 overlaying the first-data revealing portion 18. A second adhesive 30 releasably adheres the downwardly-facing second-ply surface 26 to the upwardly-facing first-ply surface 14. In some embodiments, a portion of the downwardly-facing second-ply surface 26 may be attached to the upwardly-facing first-ply surface 14 by a permanent adhesive and another portion of the downwardly-facing second-ply surface 26 may be attached to the upwardly-facing first-ply surface 14 by the second adhesive 30. For example, a zipper-style label may use a permanent adhesive to affix the outer margins of the downwardly-facing second-ply surface 26 to the upwardly-facing first-ply surface 14, while the center portion of the downwardly-facing second-ply surface 26 is releasably affixed to the upwardly-facing first-ply surface 14.

The first-data 3 is concealed by the label 10 when the downwardly-facing first-ply surface 16 is permanently adhered to the substrate surface 2 by the first adhesive 20 and the first-data concealing portion 28 of the second-ply 22 overlays the first-data 3. The first-data 3 is revealed when the first-data concealing portion 28 of the second-ply 22 is separated from the first-ply 12 and remains permanently protected by the first-ply 12.

In some embodiments, the first-data revealing portion 18 of the first-ply 12 may be a transparent material that is also a protective layer for the first-data 3. The second-ply 22 may be an opaque material that is typically but not necessarily white in color. The second adhesive 30 is preferably a dry-peel adhesive on the downwardly-facing second-ply surface 26. In some embodiments, the dry-peel adhesive may be applied to both the downwardly-facing second-ply surface 26 and the opposed upwardly-facing first-ply surface 14. The dry-peel adhesive preferably has little or no tacky adhesive residue after separation and removal of the second-ply 22 from the first ply 12. In some embodiments, a further characteristic of the dry-peel adhesive is that upon separation of the second-ply 22 from the first-ply 12, the second-ply 22 cannot be repositioned and cannot be adhesively reattached to the first-ply 12.

The second-ply 22 may have an easy-lift corner 32 facilitating separation of the second-ply 22 from the first-ply 12. The upwardly-facing second-ply surface 24 may be configured to provide evidence of tampering.

Second-data 34 is disposed on a portion of the upwardly-facing second-ply surface 24. The portion of the upwardly-facing second-ply surface 24 on which the second-data 34 is disposed may be treated with an optical medium (not shown) increasing the difficulty of making a photographic copy of the second-data 34. In some embodiments, the portion of the upwardly-facing second-ply surface 24 on which the second-data 34 is disposed may overlay the first-data 3. In other embodiments, the portion of the upwardly-facing second-ply surface 24 on which the second-data 34 is disposed may not overlay the first-data 3. Both the first-data 3 and the second-data 34 may be machine readable. The first-data 3 cannot be read until the second-data 34 is read or the second-ply 22 is removed.

In some embodiments, the substrate 1 is a stored value card, the first-data 3 is stored-value-card redemption data, and the second-data 34 is stored-value-card activation data uniquely associated with the stored value card. The stored-value-card redemption (or first) data 3 preferably comprises proprietary account data associated with an account corresponding to the activated stored value card.

Although the manner in which the label 10 is used is described below with reference to a stored-value-card, the label 10 is not limited to security applications in general or to specific applications where the first-data 3 on the substrate 1 is redemption data and the second-data 34 on the second-ply 22 is activation data. The label 10 may be used in other applications, such as where the order or sequence in which data is accessed or read is important. For example, the first-data 3 on the card or substrate 1 over which the first-ply 12 is placed can not be read until the second-data 34 on the second-ply 22 is read or at least the second-ply 22 is removed.

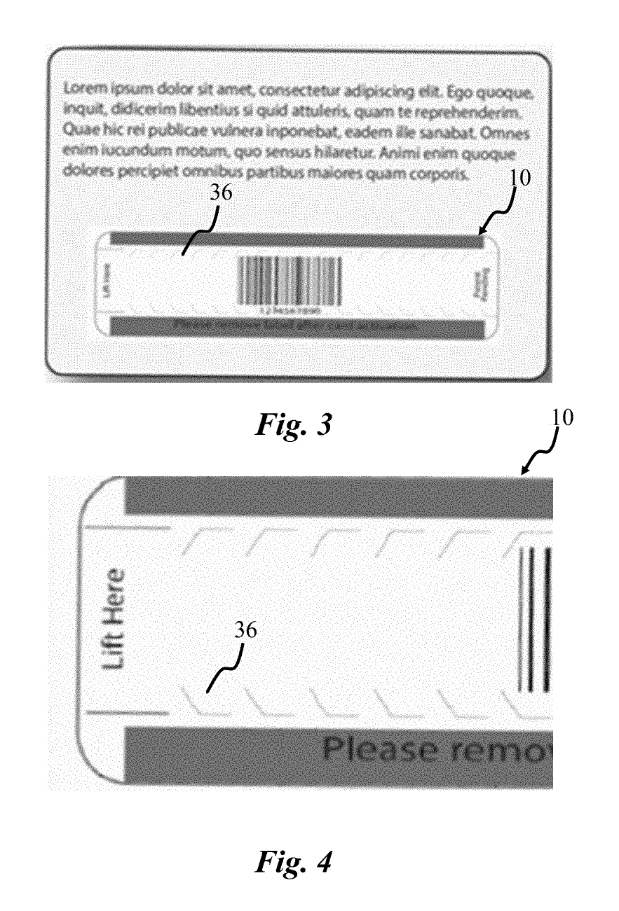

In those embodiments wherein the substrate 1 is a stored value card, the label 10 is affixed over the top of the sensitive redemption (or first) data 3, which has been imaged directly on the upwardly-facing substrate surface 2 of the stored value card. The label 10 is affixed on the upwardly-facing substrate surface 2 using the first adhesive 20 such that the first data revealing portion 18 of the first-ply 12 overlays the first-data 3. The non-sensitive activation (or second) data 34 is imaged and visible on the upwardly-facing second-ply surface 24. The upwardly-facing second-ply surface 24 may or may not contain printing in addition to the activation (or second) data 34, such as the placeholder text appearing in FIG. 3. The downwardly-facing first-ply surface 16 may, or may not, contain printing. Until the stored value card is distributed through a legitimate transaction, the label 10 effectively hides the sensitive redemption (or first) data 3 underneath.

At the point of card distribution, and in the course of a legitimate transaction, the visible non-sensitive activation (or second) data 34 that is present on the upwardly-facing second-ply surface 24 is read or scanned, triggering activation of the stored value card. After the card has been activated, the associate or the consumer removes the second-ply 22, exposing the sensitive redemption (or first) data 3 on the card (or substrate) 1 beneath. The first-ply 12 remains on the card, permanently adhered and serving as a protective layer for the redemption (or first) data 3. After separation of the second-ply 22, little or no tackiness from the dry (or second) adhesive 30 remains on the downwardly-facing second-ply surface 26 or the upwardly-facing first-ply surface 14. The removed second-ply 22 may or may not serve a secondary purpose; otherwise it may be discarded.

In the event the second-ply 22 of the label 10 were to be prematurely removed for any reason before card distribution, it is sufficiently difficult for the holder to reaffix the second-ply 22 to the first-ply 12 without obvious evidence of tampering. It is sufficiently difficult to remove the first-ply 12, or label 10 in iats entirety, from the card surface 2 without obvious evidence of tamperint. Accordingly, the label design also serves as a deterrent to criminal tampering.

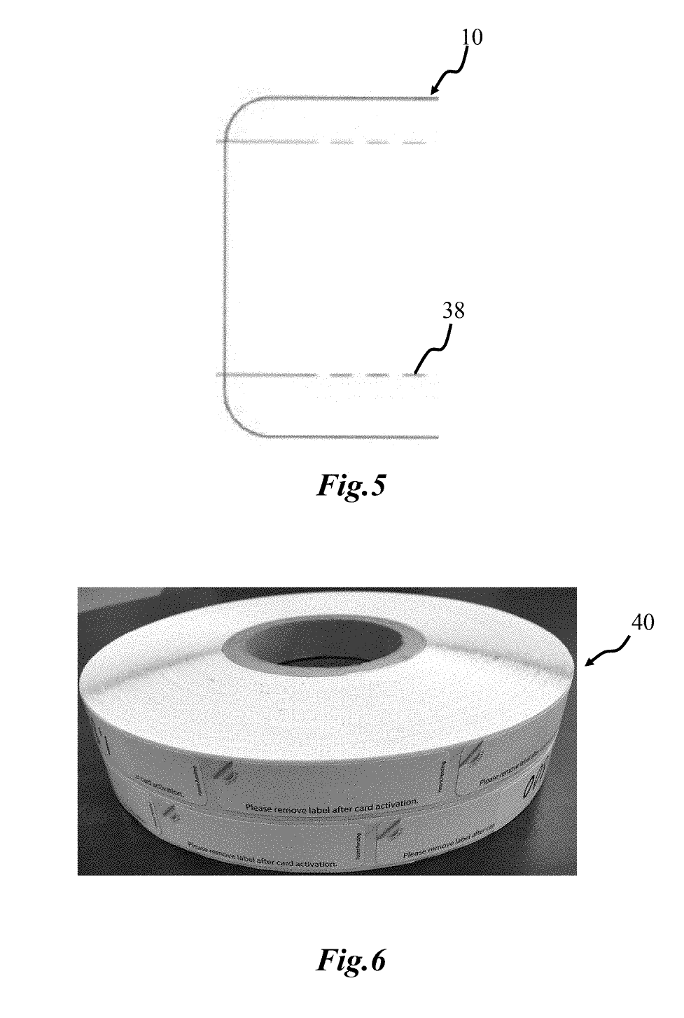

In addition to the foregoing features, in some preferred embodiments of the label the second-ply 22 may have an easy lift corner 32 to facilitate separation of the second-ply 22 from the first-ply 12 as shown in FIG. 1. In other preferred embodiments, the upwardly-facing second-ply surface 24 may have a color (e.g, red) or be treated with an optical medium such as a polarizing grid (not shown) to increase the difficulty of making photographic copies of the non-sensitive (or second) data 34 on the upwardly-facing second-ply surface 24. In still other preferred embodiments, the upwardly-facing second-ply surface 24 may be configured to provide evidence of tampering or to prevent reuse such as the labels in FIGS. 3 and 4 wherein the second-ply 22 has a central portion which covers the essential (or first) data and is separable from the edges of the second-ply 22 by spaced-apart zippers 36 or perforations or slits 38 (see, FIG. 5) that can not be reused.

The label production process may produce individual labels provided in bundles or stacks. Preferably, a plurality of labels may be produced as sheets Most preferably, the labels 10 are produced as one or more reels 40 a shown in FIG. 6.

The foregoing detailed description of the invention has been disclosed with reference to specific embodiments. However, the disclosure is not intended to be exhaustive or to limit the invention to the precise forms disclosed. Those skilled in the art will appreciate that changes could be made to the embodiments described above without departing from the broad inventive concept thereof. Therefore, the disclosure is intended to cover modifications within the spirit and scope of the present invention.

We claim:

1. A two-ply label simultaneously concealing data and revealing data for a substrate having a substrate surface with concealable first-data thereon, the label comprising:
a first-ply having an upwardly-facing first-ply surface and a downwardly-facing first-ply surface, the first-ply having a first-data revealing portion;
a first adhesive on the downwardly-facing first-ply surface;
a second-ply having an upwardly-facing second-ply surface and a downwardly-facing second-ply surface, the downwardly-facing second-ply surface opposing the upwardly-facing first-ply surface, the second-ply having a first-data concealing portion overlaying the first-data revealing portion;
a second adhesive releasably adhering the downwardly-facing second-ply surface to the upwardly-facing first-ply surface,
wherein the first-data is concealed by the label when the downwardly-facing first-ply surface is permanently adhered to the substrate surface by the first adhesive and the first-data concealing portion of the second-ply overlays the first-data, and the first-data is revealed when the first-data concealing portion of the second-ply is separated from the first-ply, and
wherein second-data is disposed and displayed on a portion of the upwardly-facing second-ply surface.

2. The label according to claim 1, wherein the first-data revealing portion of the first-ply is a protective layer for the first-data.

3. The label according to claim 1, wherein the first-data revealing portion of the first-ply is a transparent material.

4. The label according to claim 1, wherein upon separation of the second-ply from the first-data revealing portion of the first-ply, the second-ply is not repositionable relative to the first-data revealing portion of the first-ply and cannot be adhesively reattached to the first-ply.

5. The label according to claim 1, wherein the second-ply has an easy-lift corner or edge facilitating separation of the second-ply from the first-ply.

6. The label according to claim 1, wherein the upwardly-facing second-ply surface is configured to provide evidence of tampering.

7. The label according to claim 1, wherein the portion of the upwardly-facing second-ply surface on which the second-data is disposed is treated with an optical medium increasing the difficulty of making a photographic copy of the second-data.

8. The label according to claim 1, wherein the portion of the upwardly-facing second-ply surface on which the second-data is disposed does not overlap the first-data.

9. The label according to claim 1, wherein the first-data is machine readable and the second-data is machine readable.

10. The label according to claim 9, wherein the first-data cannot be read until the second-data is read or the second-ply is removed.

11. The label according to claim 1, wherein the substrate is a stored value card, the first-data is stored-value-card redemption data, and the second-data is stored-value-card activation data uniquely associated with the stored value card.

12. A substrate comprising:
a substrate surface;
a concealable first-data on the substrate surface; and
the two-ply data according to claim 1 wherein the downwardly-facing first-ply surface is permanently adhered to the substrate surface by the first adhesive, second-data is disposed on a portion of the upwardly-facing second-ply surface, the first-data concealing portion of the second-ply overlays the first-data, and the first-data is revealed when the first-data concealing portion of the second-ply is separated from the first-ply.

13. The substrate according to claim 12, wherein the portion of the upwardly-facing second-ply surface on which the second-data is disposed does not overlap the first-data.

14. The substrate according to claim 12, wherein the substrate is a stored value card, the first-data is proprietary account data necessary to use the stored value card for value, and the second-data is stored-value-card activation data uniquely associated with the stored value card.

15. The substrate according to claim 14, wherein the portion of the upwardly-facing second-ply surface on which the stored-value-card activation data is disposed does not overlap the redemption data.

16. A method for securely activating a stored value card comprising:
providing a stored value card having first-data on a surface thereof, the first-data being stored-value-card redemption data; and
affixing the label according to claim 1 on the surface of the stored value card using the first adhesive, such that the first-data revealing portion of the first-ply overlays the first-data;
disposing second-data on a portion of the upwardly-facing second-ply surface, the second-data being activation data; and
activating the stored value card by reading the second-data at a point-of-distribution; and
removing the second ply.

17. The method according to claim 16, wherein the stored-value-card redemption data comprises proprietary account data associated with an account corresponding to the activated stored value card.
